(19) United States
(12) Patent Application Publication
(10) Pub. No.: US 2026/0360997 A1
(43) Pub. Date: Nov. 12, 2026

(54) COG ANTENNA AND STATION COMBINING METHOD

(71) Applicant: ELECTRONICS RESEARCH, INC.

(72) Inventor: ROBERT ROSE, EVANSVILLE, IN (US)

(21) Appl. No.: 19/668,977

(22) Filed: May 6, 2026

Related U.S. Application Data
(60) Provisional application No. 63/800,888, filed on May 6, 2025.

(51) Int. Cl. H01Q 21/26; H01Q 1/24

(52) U.S. Cl. CPC H01Q 21/26; H01Q 1/246

(57) ABSTRACT

An antenna system for FM broadcasting includes multiple radiating elements arranged in bay levels within an antenna module. A single 4-port hybrid coupled to the antenna module, configured to receive multiplexed signal groups and generate phase-shifted output signals for the radiating elements. A power divider distributes these signals, a balun transforms them to balanced signals for orthogonally positioned dipoles, which radiate circularly polarized waves. The system can generate independent circularly polarized waves from different input ports. The antenna module features a flanged tubular spine with structural wings acting as corner-reflectors, and flanged legs for stacking additional modules. Each radiating element includes a pressurized case and insulator, with dipoles in bent configuration. The system operates across 88 MHz to 108 MHz and includes combiner modules for signal integration from multiple FM stations. A radiating element for circularly polarized broadcasting features orthogonally positioned dipoles with inherent phase shift for wave radiation.

### BACKGROUND OF THE INVENTION

### Field of the Invention

This disclosure relates generally to antennas capable of broadcasting FM signal in digital and/or analog, and more particularly to an improved cog antenna for broadcasting digital and analog FM signals and an improved combining method.

### Description of the Related Art

As shown in FIG. 1, Electronics Research, Inc. (ERI) developed and sells the ERI COGWHEEL™ FM antenna system. https://eriinc.com/product/cogwheel-antenna-support-structure/. Capable of operating across the FM band, it combines high power handling capabilities, outstanding radiation characteristics and mounting flexibility to existing structures.

The COGWHEEL™ can be used as a single or multi- station antenna. The COGWHEEL™ antenna system allows several high powered stations to benefit from its cost efficiency, superior radiation qualities and state-of-the-art technology.

Radiating elements are made of brass and copper. Masts and screens are hotdip galvanized. Stainless steel hardware is used throughout. These outstanding features provide performance and durability. The unique design of the COGWHEEL™ eliminates the need for electrical deicing. Its feed points, baluns and feed couplers are enclosed in a pressurized environment. Optional element radomes or deicing heaters are available for use in remote areas where severe icing is expected.

The COGWHEEL™ is designed with three or four ERI Type 1180 radiating elements at each level. Screening is provided to isolate the support structure and control adjacent element coupling. Pole mounted systems incorporate the mounting pole in the system design.

The COGWHEEL™ produces a horizontal plane relative field pattern of ± 1.5 dB circularity (when pole mounted) over the FM band. Beam tilt and null fill are available. Vertical plane relative field patterns are available upon request to determine individual station gain. At one wavelength element spacing, gain is approximately one-half the number of element levels.

The COGWHEEL™ uses single or dual transmission line in-puts. With the use of a dual line system, the COGWHEEL™ can continue to operate on one half of the antenna in the unlikely event of a failure in the other half.

The existing COGWHEEL™ antenna was designed for use with broadcasting groups of FM stations that may wish to broadcast both in Analog and Digital IBOC using either Common-Mode or independent transmitters. However, the existing COGWHEEL™ antenna can deliver excellent coverage patterns for two groups of FM radio stations when using a special multiplexing arrangement. Furthermore, the improved COGWHEEL™ antenna of the present invention uses a single Hybrid per Cog Module in place of six hybrids which drastically reduces fabrication cost. The improved COGWHEEL™ antenna of the present invention also has enhanced electrical isolation between modules as compared to the prior art systems. The present invention further introduces a new “Reentry Type” hybrid to enhance power handling capability and improve performance module S-Parameters performance. The two identical 6-Way, Center fed Power Dividers of the present invention are blended into the structure. The existing COGWHEEL™ antenna includes stackable modules that use a single feed and 3-Port Hybrids (in lieu of 4) located behind elements. Although the improved COGWHEEL™ antenna of the present invention can be used in single fed system, it has been redesigned for enhanced performance using a common 4-port hybrid per module.

FIG. 2 shows a combiner scheme depicting two groups of FM stations, combiner station group one 2 and combiner station group two 3, having independent operating transmitters feeding dual runs of transmission line 5, 6 respectively for RHCP and LHCP operation. Each of the combiner station groups is comprised of a plurality of combiner modules 4, such as a typical ERI 963-8 type combiner module as shown in FIG. 2. The frequencies can be alternated between each group. This procedure has the advantage of placing closely spaced channels which could be at 800 kHz spacing into different groups.

An optional connecting link line 7 may be provided to link combiner station group one 2 to combiner station group two 3 and is required to send station injected Digital signals through one another’s multiplexed combiner string of modules. If all stations are using Analog + Digital transmitters (common mode), the link may be removed. With the link removed, a load resistor must be installed to the end connection of each Combiner Unit.

FIG. 2 shows the two groups 2, 3 of seven combiner units 4 arranged in series. Each unit 4 is assigned a frequency number for its station, therefore, a total of 14 units are shown. Combiner station group one 2 is required to have its multiplexed energy fed via transmission Feed-One 5 to the Right-Hand Circular Polarized (RHCP) operating port of a COGWHEEL™ Antenna. Combiner station group two 3 is then expected to have its multiplexed energy fed via transmission Feed-Two 6 to the Left-Hand Circular Polarized (LHCP) operating port of a COGWHEEL™ Antenna. The Station multiplexing scheme is configurable for a varying number of stations. Circulators 8 are shown connected to Combiner Units 4 to enable supplemental Digital Transmitters to be added into the multiplexing scheme. For any station adopting common mode, Analog + Digital transmitters, a load resister must be substituted for the circulator’s removal.

The energy output from combiner station group one 2 is arbitrarily assigned to transmission Feed-One 5 to broadcast in RHCP mode from the COGWHEEL™ antenna. The back-fed energy from the digital transmission of combiner station group one 2 will broadcast in LHCP mode from the COGWHEEL™ antenna which is feed from transmission Feed-Two 6.

Similarly, the energy output from combiner station two 3 is arbitrarily assigned to transmission Feed-One 5 to broadcast in RHCP mode from the COGWHEEL™ antenna. The back-fed energy from the digital transmission of combiner station group two 3 will broadcast in LHCP mode from the COGWHEEL™ antenna which is fed from transmission Feed-Two 6.

There are four benefits realized in adopting this practice. One, the ill effect on one another’s group delay response due to placing adjacent closely spaced frequency modules next to one another is eliminated. Two, now the two groups of stations are autonomous and can be fed into two transmission lines to make use of the two modes of broadcasting in the COGWHEEL™ antenna of the present invention. Three, the peak voltage and current of the two transmission lines in use are now reduced with fewer stations operating into each transmission line. Four, the combining scheme enables Digital IBOC to either be broadcast simultaneously with Common Mode Transmitters 9A or alternately using a combiner unit’s injection Hybrid, Port-2 9B, that is normally connected to a load resister for constant impedance effect (i.e., residual dump load, or circulator).

An RF circulator is typically a three port, Y-junction having a one-way sense of RF signal flow. As shown in FIG. 2, for example, with a signal injected at Port-A of the circulator, its energy is transferred to an output load at Port B in a clockwise direction and is isolated from Port-C, which is normally terminated in a 50 Ohm load. Any spurious signal directed into Port-B travels to the load.

Accordingly, there is a need for an improved COGWHEEL™ antenna with omnidirectional radiation patterns in the horizonal plane and providing vertical-plane pattern shaping capability. There is also a need for an antenna with both Right-Hand and Left-Hand circular polarized waves that could be broadcasted from independent feed lines that are fed by two groups of FM radio stations operating in unison.

### SUMMARY OF THE INVENTION

It is therefore an object of the present invention to provide to a broad-band, 88-to-108 MHz antenna with omnidirectional radiation patterns across the FM band in the horizontal plane and providing vertical-plane pattern shaping capability.

It is also an object of the invention to provide both Right-Hand and Left-Hand circular polarized waves that could be broadcast from independent feed lines that are fed by two groups of FM radio stations operating in unison. This type of operation must be conducted in such a way as to provide a certain degree of isolation between station transmitters and not impose any degradation to any station’s signal quality. This places a significant burden on the radiating elements used by the antenna of the present invention. The two isolated input ports work simultaneously and independently to achieve these goals.

The present invention meets these objectives by providing a COGWHEEL™ antenna that is an integrated free-standing support structure, feed harness and bay level broadcasting elements which functions as a modular antenna capable of operating concurrently at high power Analog and Digital RF carrier levels within the FM frequency band. The antenna is capable of accepting several multiplexed FM station transmitters. The preassembled components consisting of structure, elements, and feed harness of the COGWHEEL™ antenna of the present invention will deliver excellent coverage patterns for two groups of FM radio stations when using a special multiplexing arrangement.

The present invention further meets these objectives by substituting the Hybrid’s load resistor for circulator units to permit the injection of a high power, -10 dBc, IBOC signal into the multiplexing scheme while also maintaining the constant impedance characteristics of a combiner module.

Certain aspects of the present disclosure provide an antenna system for FM broadcasting. The antenna system generally includes a plurality of radiating elements arranged in bay levels within an antenna module. The antenna system generally includes a single 4-port hybrid coupled to the antenna module, which comprises a first input port, a second input port, a first output port, and a second output port. The single 4-port hybrid is configured to receive a first multiplexed signal group at the first input port and a second multiplexed signal group at the second input port and to generate phase-shifted output signals at the first output port and the second output port for the plurality of radiating elements. The antenna system generally includes a first power divider connected to the first output port and a second power divided connected to the second output port of the single 4-port hybrid, configured to distribute the phase-shifted output signals to the plurality of radiating elements. The antenna system generally includes a balun associated with each radiating element, each configured to transform an unbalanced signal to a balanced signal. The antenna system generally includes a pair of orthogonally positioned dipoles within each radiating element, configured to receive the balanced signal from the balun and to radiate circularly polarized electromagnetic waves. The antenna module is configured to generate a first circularly polarized wave from the first input port and a second circularly polarized wave from the second input port simultaneously and independently.

Certain aspects of the present disclosure provide a radiating element for circularly polarized broadcasting. The radiating element generally includes a first dipole and a second dipole positioned orthogonally to each other, wherein the first dipole comprises a first physical length and the second dipole comprises a second physical length different from the first physical length. The radiating element generally includes a gap-fed balun coupled to the first dipole and the second dipole, configured to receive a single input signal and to provide a balanced feed to the first dipole and the second dipole. The difference between the first physical length and the second physical length creates an inherent phase shift of approximately 90 degrees between the first dipole and the second dipole. The first dipole and the second dipole are configured to radiate a circularly polarized electromagnetic wave based on the inherent phase shift and the orthogonal positioning.

These and other objects, features and advantages of the present invention will become apparent from a review of the following drawings and detailed description of the preferred embodiments of the invention.

### BRIEF DESCRIPTION OF THE DRAWINGS

The present invention can best be understood in connection with the accompanying drawings. It is noted that the invention is not limited to the precise embodiments shown in the drawings, in which:

FIG. 1 is a perspective view of a COGWHEEL™ antenna according to the prior art.

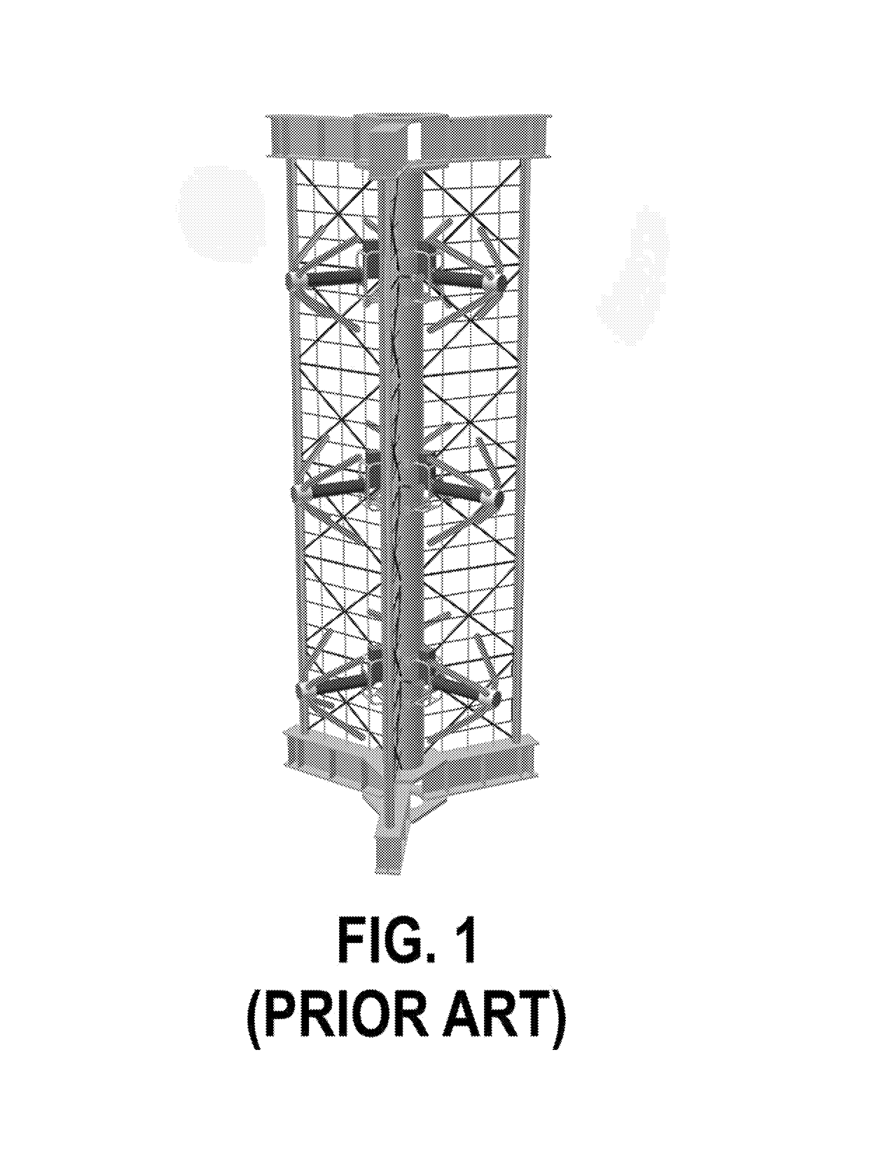

FIG. 2 is a diagram of a combiner scheme pointing out two groups of FM stations having independent, operating transmitters according to the present invention.

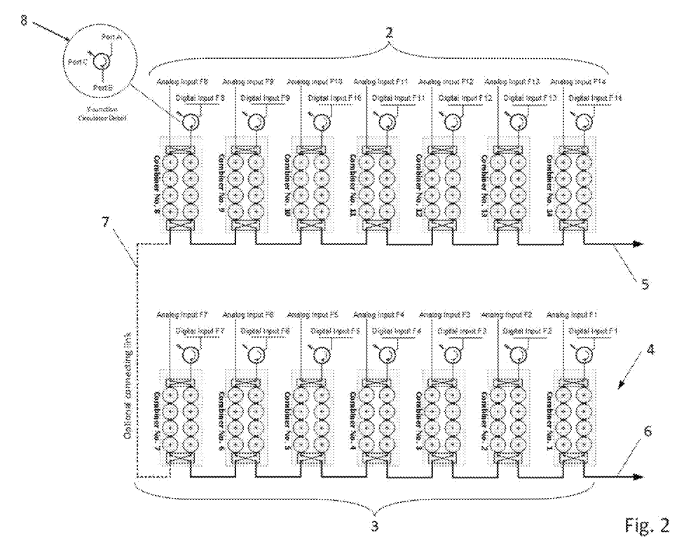

FIG. 3 is a perspective view of a COGWHEEL™ antenna according to one presently preferred embodiment of the invention.

FIG. 4 is a perspective view of a radiating element from the cog antenna shown in FIG. 3.

FIG. 5A is a cutaway view of a 4-port, 3db, 90 degree hybrid used in connection with a preferred embodiment of the invention.

FIG. 5B is side view in partial and full cross section of the tubular baluns used in connection with a preferred embodiment of the invention.

FIG. 5C is an end view of the radiating element shown in FIG. 4 with the end cap removed to reveal right and left slant dipole balun outputs and feed strap arrangements and indicating RHCP rotation.

FIG. 5D is an end view of the radiating element shown in FIG. 4 with the end cap removed to reveal right and left slant dipole balun outputs and feed strap arrangements and indicating LHCP rotation.

FIG. 6A is a perspective view of a radiating element from the COGWHEEL™ antenna shown in FIG. 3 according to a further embodiment of the invention with certain sections shown in cutaway.

FIG. 6B is a side elevation view of the section 6B shown in FIG. 6A.

### DETAILED DESCRIPTION OF THE INVENTION

For the purposes of promoting an understanding of the principles of the embodiments described herein, reference is now made to the drawings and descriptions in the following written specification. No limitation to the scope of the subject matter is intended by the references. This disclosure also includes any alterations and modifications to the illustrated embodiments and includes further applications of the principles of the described embodiments as would normally occur to one skilled in the art to which this document pertains.

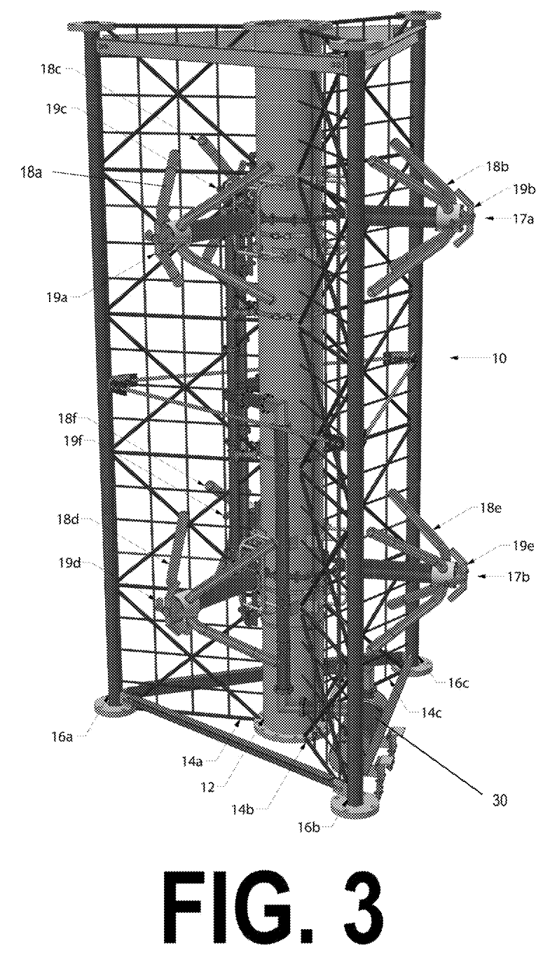

As best shown in FIG. 3, one presently preferred embodiment of the invention comprises a COGWHEEL™ antenna 10 having a flanged tubular spine 12 that joins three structural wings 14a, 14b, 14c used for pattern shaping of the antenna’s element energy. The outreaching wings 14a, 14b, 14c connect to flanged legs 16a, 16b, 16c that allow for stacking of additional COGWHEEL™ antenna modules of the same design. The wings 14a, 14b, 14c of the COGWHEEL™ antenna 10 serve as corner-reflectors with dimensions and grid patterns tuned for best FM pattern performance. The COGWHEEL™ antenna frame 10 incorporates two bay levels 17a, 17b of three-around radiating elements 18a, 18b, 18c, 18d, 18e, 18f located symmetrically around the modular support spine 12 of the COGWHEEL™ antenna frame 10 and its rigid feed harnesses. The harness arrangement normally distributes phased power uniformly to each of the COGWHEEL™ antenna elements 18a, 18b, 18c, 18d, 18e, 18f. However, in custom vertical-plane and horizontal-plane pattern reshaping designs, the power and phase can be distributed unevenly using a modified feed harness with special transformers and lump reactance slugs.

Each bay level 17a, 17b uses built in niches formed from tuned corner reflectors and platforms to isolate the direct signals from adjacent elements while also broadcasting in the far-field an omnidirectional horizontal-plane pattern shape. With custom phasing and proportional power fed to each module’s elements, directional horizontal-plane pattern shaping is possible. The standard feed harness offers a typical vertical-plane pattern however beam-tilt and/or null-fill can be introduced.

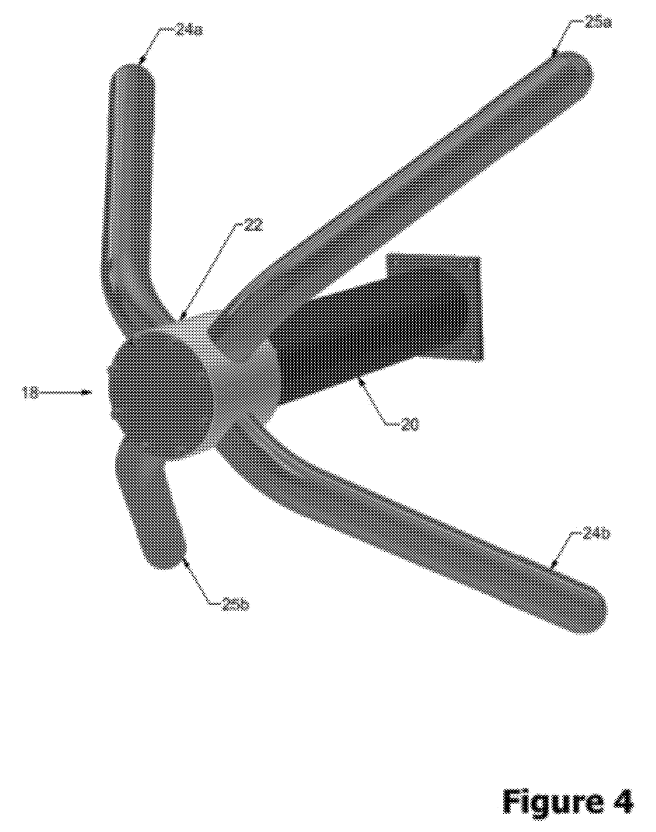

As best shown in FIG. 4, each cog antenna element 18 includes a 6-1/8” pressurized case 20 that offers the confinement and the mechanical support for the element’s two unbalanced-to-balanced Baluns and a large industrial Melamine insulator 22. The thick-walled insulator 22 is weather protected with coated high voltage silicone and supports the radiating element’s two orthogonal placed, bent dipoles – a first right/slant (R/S) dipole 24, and a second left/slant (L/S) dipole 25. Each element dipole 24, 25 is separated into arm segments 24a, 24b and 25a, 25b, respectively, and each segment is fed by the Balun’s unique balanced transmission output that works well over the complete FM Band. According to preferred embodiments of the invention, 3 inches to 6 inches, may be used. The consequence of using a smaller arm dipole is that it has smaller cylindricalness (length vs circumference dimensions) and has a somewhat diminishing effect on bandwidth.

The wings 14a, 14b, 14c of the cog antenna 10 serve as corner reflectors with the cog antenna’s 3-around radiating elements 18a, 18b, 18c, 18d, 18e, 18f placement and bent dipole radiating arms 24a, 24b, 25a, 25b. The interaction for each element 18a, 18b, 18c, 18d, 18e, 18f and wings 14a, 14b, 14c delivers field patterns that when all are summated in the far-field are omnidirectional. Yet the emanating energy (radiated) out is nulled to adjacent bay level elements.

The two dipoles 24, 25 of each radiating element 18 are made up of four segments or arms 24a, 24b, 25a, 25b. The individual, element-arm feed impedances are approximately 100 Ohms and can be preserved in the Balun’s two quarter-wave transmission Branches “A” and “B”. The Baluns branching coax, characteristic impedance is based on using a 1-5/8” conductor outer (.049 wall) with a 5/16 dia. inner which provides a characteristic impedance (Zo) of 95 Ohms. However, the conductors are often substituted with slightly altered diameters conductors to improve the element bandwidth match when the structure, element, and harness is fine tuned.

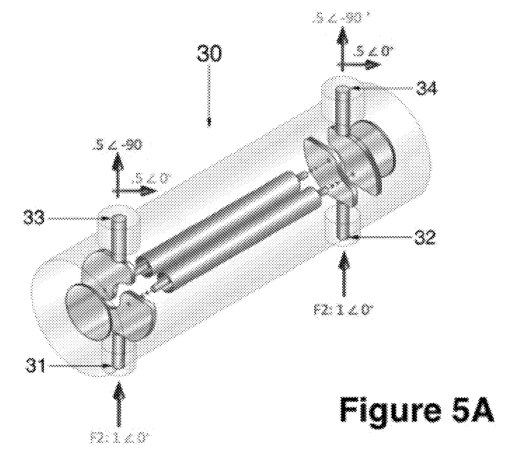

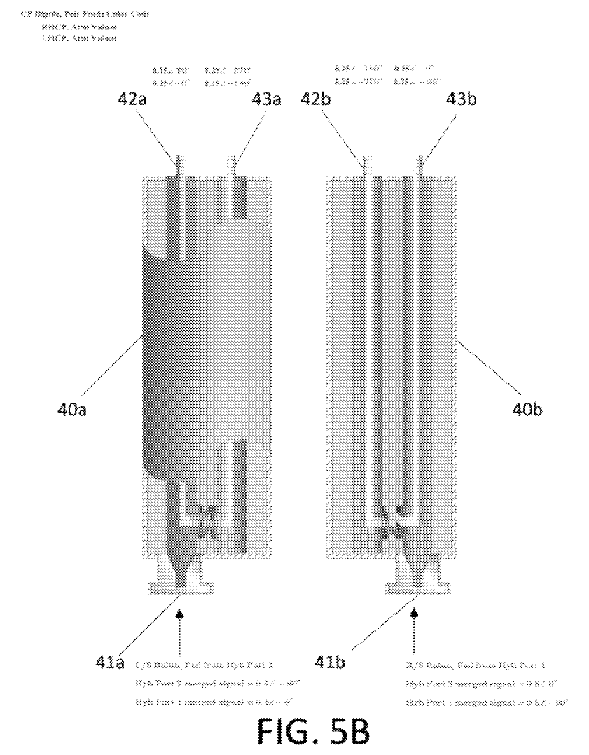

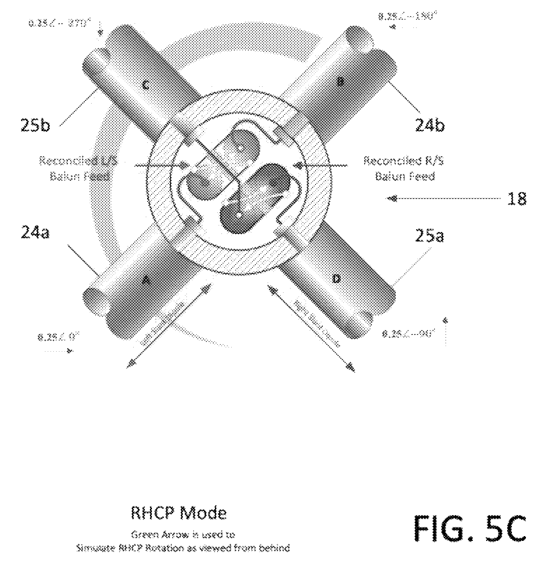

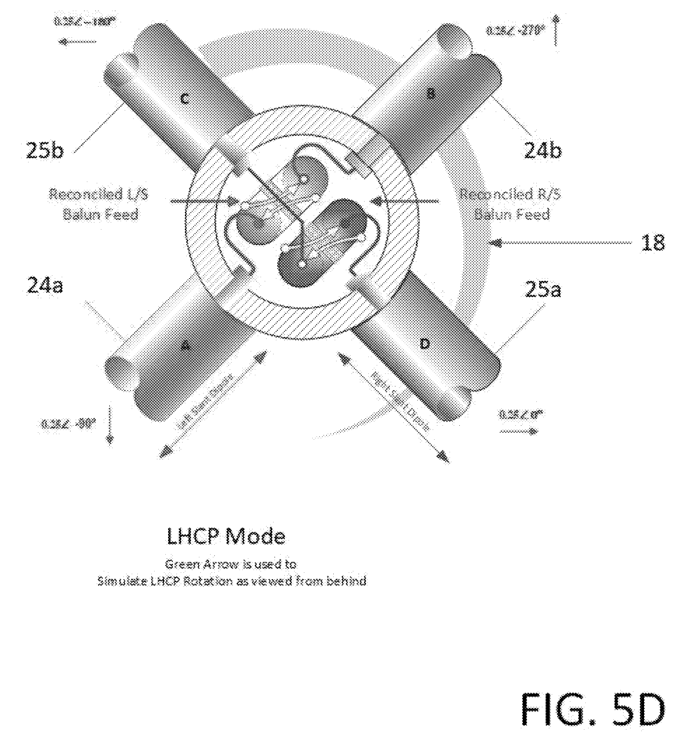

Both the Right/Slant Dipole 24 and Left/Slant Dipole 25 operate identically, except for the imposed 90^{o} signal delay on one slant relative to the other from a feed harness Hybrid. This delay is introduced in the feed harness from a 3dB, 90 Degree Hybrid 30, as shown in FIG. 5A. The ± AC wave energy through the actions of the 90^{o} Hybrid and the elements two 180^{o} Baluns equally divides the power between the Dipole arm segments. The pressurized 3dB, 90 degree hybrid is not of an ordinary design and construction. It is robust to handle the peak voltage and current associated with operating simultaneous Analog and Digital IBOC high-power levels of several multiplexed station frequencies.

From the radiation resistance of the elements 18 in the electromagnetic field, the load resistance of the dipoles is transformed, phased and reactance corrected to keep its impedance locus of points under control (contained in a small VSWR circle). Stubs may be provided to cancel unwanted reactance.

FIGS. 5A-5D illustrate the COGWHEEL™ Antenna’s basic components that are used to broadcast two independent Right Hand and Left Hand Circular Polarized groups of signals. These components are essential to create the two independent RHCP and LHCP radiating waves which enable operation by separate groups of radio station transmitters. FIGS. 5A-5C also show the phase distribution to the dipoles arm segments 24a, 24b, 25a, 25b for a particular Hybrid input port. These phase differences caused by a continuous AC signal cycle cause a circularly polarized radiated field either having a Right-Hand or Left-Hand direction of rotation dependent on the chosen input port of the Hybrid. The subsequent detail offers a brief description of the actions taken by the Baluns.

FIG. 5A shows a 4-Port, 3db, 90 degree hybrid component 30 used as a power divider and phasing device for two independent groups of FM radio stations. A first hybrid input port 31 is utilized by a Station Frequency or a Station Group to operate in LHCP Mode. A second hybrid input port 32 is utilized by a Station Frequency or a Station Group to operate in RHCP Mode. The hybrid component 30 further includes a first output port 33 and a second output port 34. Arrows shown above the first output port 33 and second output port 34 in FIG. 5A indicate the phase of merged signals from F1 and F2 from the first input port 31 and second input port 32.

The first output port 33 and second output port 34 are indirectly fed to the first element balun 40a and second element balun 40b shown in FIG. 5B. The L/S unbalanced output from the first output port 33 of the hybrid 30 is fed into the input port 41a of the first element balun 40a, while the R/S unbalanced output from the second output port 34 of the hybrid 30 is fed into the input port 41b of the second element balun 40b. The first element balun 40a and second element balun 40b are used to transform unbalanced signals fed to its respective input ports 41a, 41b into two sets of balanced outputs at output ports 42a, 42b, 43a, 43b for R/S and L/S Dipole feeds.

FIGS. 5C and 5D are front end views of the antenna element 18 shown in FIG. 4 with cap removed to reveal right and left Slant Dipole Balun outputs and the feed strap arrangement. The green arrow in FIG. 5C is used to show RHCP rotation as viewed from behind. Similarly, the green arrow in FIG. 5D is used to show LHCP rotation as viewed from behind. FIGS. 5C and 5D are identical, apart from the added circular arrow to indicate broadcast mode rotation (i.e., RHCP in FIG. 5C and LHCP in FIG. 5D). The sense of rotation is drawn in accordance to delaying phase angles.

Immediately inside the input ports to the Right/Slant Dipole 24 and Left/Slant Dipole 25 is the inner conductor connection to a choke-cavity formed from the inside diameter of the case and a non-concentric, single-ended choke 1-5/8” dia. conductor that is grounded at its opposite end. The choke connection is also shared with the innermost conductor of one of the two coax branches through the Balun’s coupling gap. The coax branch inner conductor, after conducting over a quarter-wavelength, connects to a first dipole arm segment 24a or 25a. The opposing dipole arm segment 24b or 25b, in a likewise fashion, is attached to the inner conductor then travels through one of the coax branches to make a connection across the gap to the opposing branch which is grounded to the Balun case. These connections represent a balanced circuit in the innermost Branch lines A and B that feed the dipole with a 180^{o} phase difference.

Across the Baluns coupling gap, innermost conductors A and B impedances are placed in parallel to produce an approximate 50 ohm match over the FM Band (88-to-108 MHz). Another excellent trait of the Balun is associated with its wide-band, FM operation in providing equal power two its Right\Slant and Left/Slant dipoles with a 180^{o} difference. Furthermore, the two Baluns share the same outer cavity and choke that are electrically isolated from one another. Moreover, the large tubular dipoles provide the necessary FM impedance match and bandwidth to the 180^{o} Baluns to generate a 50 Ohm approximate impedance. Lastly, the dipole feed circuit is so arranged to route feed straps to designated dipole arms.

Cog Radiation patterns are controlled by the unique geometry of the Cogs support, isolating wing structure, and Cog elements. The components along with crucial placement of all rigid feed harness and its grounding work in harmony to achieve coexistence without unjustified interaction between the active Cog elements and surrounding harness and deliver pattern performance.

Parasitic crosses 19 may be provided on the elements 18 and introduced into the field of the elements 18. This cross has a conjugate reactance canceling effect and a strong influence on the element’s two dipole’s fields. The influence enhances the mutual dipole isolation. The elements’ internal two Baluns, transformers, and corrective reactance slugging preserve the curl impedance delivered to the two independent multistage power dividers. The power dividers’ output fed by rigid coax until connections are made to a newly designed, four port, 3db 90^{o} hybrid unit.

The antenna of the present invention allows station frequencies to stay autonomous yet radiate in two circular modes. The distance between the first cog bay level 17a and the second cog bay level 17b from stacking modules and with control of the elements power amplitude and phase from the complex feed distribution system, gives us near uniform antenna gain figures.

The cog antenna’s modular construction and all rigid coax element phase and power feed harness special alterations can be made easily to reshape the vertical pattern for given circumstances. Components of the all-rigid fed cog antenna are easily sized-up without disruption to the Cog’s performance (i.e., port matches, operating mode isolation and pattern performance). Both Analog and Digital station broadcasting are handled simultaneously for a multitude of stations.

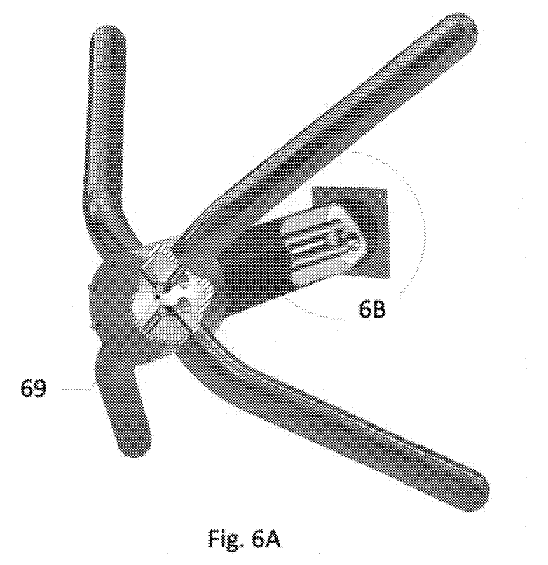

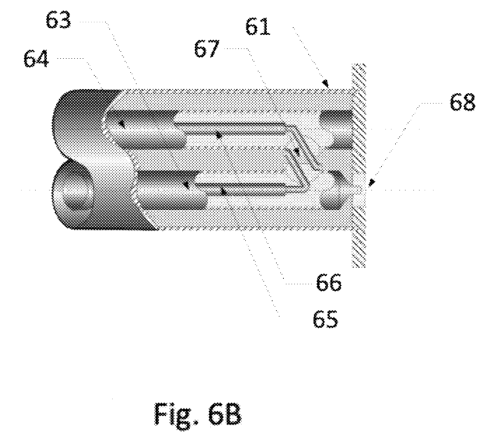

FIGS. 6A and 6B illustrate a Cog element according to a preferred embodiment that is capable of broadcasting a circularly polarized signal using Circular Polarizing Concept “CPC” with the cog’s elements which use a gap-fed Balun. The elements produce a circular polarized signal by making the elements’ dual set of cross Dipoles have relative length differences. When the concept is used in conjunction with a gap-fed Balun, a broadcasting elements performance has an extensive broadband frequency behavior.

During development of the ERI 1080 crossed dipole panel elements, it was discovered that relatively small dipole length deltas resulted in significant reflection phase deltas. Subsequent investigation revealed that thusly rotating one of the two dipole’s impedance curls relative to the other about a normalized Smith chart resulted in a phase shift which is ideal for circularly polarized broadcast when the crossed dipole pair is fed from a common two-port connection of a single 180-degree phase shifting balun.

Independent crossed dipole element impedance measurements using an external probe technique revealed that this approach can have two main benefits. (1) Similar impedance curls having complimentary phase relationships for impedance matching, and (2) a 90-degree propagation phase delta, which results in a circularly polarized broadcasting property without the need for a supplemental 90-degree phase shifting device, such as a hybrid. By using a 180-degree gap-fed balun and coaxial transformers, a broadband near 50-ohm element impedance was attainable resulting in a simplified, high performing, multi-station element using the well-established Circular Phasing Concept (CPC).

By interconnecting a gap-fed/choke-cavity Balun, a CP element could be produced using fewer parts than the current model elements. Also, the CPC method of broadcasting can adapt to a low power element built from a unified galvanized frame. Both prior art models traditionally used a 90^{o} 3dB Hybrid for dual mode simultaneous right-hand and left-hand broadcasting (i.e., RHCP and LHCP acronym). The benefit of using the element Hybrid had been that it provides a group of Radio Station broadcasters with the ability of simultaneous broadcast while using the dual RHCP and LHCP broadcast ports of a legacy dual mode Cog Master Antenna system.

In the present embodiment shown in FIG. 6A, the COGWHEEL™ ’s element’s dual set Dipoles are fed in parallel (shunt fed) as shown in element cutaway. In this embodiment a single Balun is surrounded by a pressurized choke cavity. The choke cavity is used for supporting the dual set of Dipoles attached to the element’s fiberglass/melamine insulator. The element has but one coaxial input port in this incarnation at the far end of where Dipoles attach.

The transmission of energy using the CPC broadcast concept using a single unbalanced coax interfaced with a 180^{o} balanced Balun device can only be operated in one of the two circular polarized signal rotations (e.g., RHCP or LHCP). Broadcasting with a single Balun was found to have limited frequency performance (pattern bandwidth) when considering all the usual qualifying factors when operation is to broadcast covering the full FM bandwidth. The challenge to enhance these broadcast factors was met with feeding the CPC broadcast concept with a gap-fed Balun. The uniqueness is that the Balun functions with dual balanced transmission lines connected to a set of orthogonally placed Dipoles broadcasting using the CPC concept. To arrive at a Cog Module’s circular pattern performance, Balun-fed Dipole sets of elements are operating in unison when placed symmetrically within the niches of a Cog structure yet have electrical isolation with one another. Also, several of these Balun-fed cross Dipoles can be mounted to flat panel structures and placed symmetrically around a tower structure for directional or omni-directional broadcasting.

When striving for broad-band circular polarized broadcasting for use with multi-stations operating at high power levels, several broadcasting elements are required, that must be built to radiate within the electromagnetic field with a rotating voltage vector (i.e., CP broadcasting). These bays must work with all other Bays in unison yet have electrical isolation. This is generally done with two dipoles built within each element which are fed with a station or stations signal transmission that must undergo a special unbalanced coax input to a balanced feed system.

As shown in FIG. 6B, within the element’s choke cavity 61, there is provided a gap-fed Balun that uses two 1/4 wave coaxial lines 63, 64 in its construction. Situated within 1/4 wave lines sections are identical conductors 65, 66 used for impedance transformation.

The energy fed from an unbalanced coax feed input is coupled with the Balun’s two balanced coaxial lines through a gap 67 placed between the two-line sections. It is within these two lines that the Dipole’s impedance load created from the electromagnetic field radiating resistance is transformed into a nominal 50 Ohm Balun input 68. The necessary choke cavity 61 which promotes the coupling is around the gap in the unbalanced side of the Balun structure. Opposite the unbalanced side of the choke cavity 61 exists a ground plane. The two-line sections slightly pierce the ground plane without disturbing the broad-band, perfect balance between them. The transforming line section inners are now extended out 69 to connect to the dual set of Dipole’s poles that have been grouped to promote circular polarized excitation.

FIG. 6A shows the Balun’s transforming feed conductors extended out from the choke cavity’s far end ground-plane which shares in support the Dipole’s insulator. The extensions tie to the set of Dipoles poles which share a common feed terminal. At the opposing end of the choke cavity from the Dipole fed end is the Balun’s coaxial input unbalanced port, where the input coax inners attach to the Balun gap. The transforming coax line sections have inner conductors so chosen to give a Zo impedance that will step-down the high Dipole’s common connection impedance to a nominal 50 Ohm element input impedance. The choosing of inner conductor diameters for the two coax lines is specifically sized to handle multi-station use at high power.

The impedance load created from the Dipole’s resistance to radiation within the electromatic field is conducted by two-coax balanced lines and their inner conductors to the Balun gap connection’s opposing two sides resulting in an electrical parallel combining of the Dipole feed loads. Not shown in FIGS. 6A and 6B is the possibility of making a series of electrical connections to the feed. In this type of connection, the transforming inners are joined continuously together looping through the gap (i.e., no physical connection is made to the gap). The parallel connection results in a balanced to unbalanced impedance transformation ratio of two.

FIGS. 6A and 6B the detail of the Balun’s two coax sections with their inner conducting transformers connected to opposing sides of the Balun’s coupling gap is shown. The two inner conductors attached to the gap provide the necessary 180° Dipole balanced phasing to the element Dipole’s two common connected adjacent poles. This arrangement represents an improvement over other types of Baluns due to the ability of a Balun and its connections to operate protected from inclement weather in a pressurized environment. This gives the system a higher power capability compared to other available technologies. Also, due to the gap feed system with the choke cavity surrounding the gap in the unbalanced side of the Balun structure, each adjacent fed Dipole’s poles have the same counterparts and are thus fed with equal voltage independent of operating frequency. These features represent a marked improvement in performance over other available technologies use of the CPC concept.

This detailed description, and particularly the specific details of the exemplary embodiment disclosed, is given primarily for clearness of understanding and no unnecessary limitations are to be understood therefrom, for modifications will become evident to those skilled in the art upon reading this disclosure and may be made without departing from the spirit or scope of the claimed invention.

I/We claim:

1. An antenna system for FM broadcasting, comprising:
a plurality of radiating elements arranged in bay levels within an antenna module;
a single 4-port hybrid coupled to the antenna module, the single 4-port hybrid comprising a first input port, a second input port, a first output port, and a second output port, wherein the single 4-port hybrid is configured to receive a first multiplexed signal group at the first input port and a second multiplexed signal group at the second input port and to generate phase-shifted output signals at the first output port and the second output port for the plurality of radiating elements;
a first power divider connected to the first output port and a second power divider connected to the second output port of the single 4-port hybrid, the first and second power dividers configured to distribute the phase-shifted output signals to the plurality of radiating elements;
a balun associated with each radiating element of the plurality of radiating elements, each balun configured to transform an unbalanced signal to a balanced signal; and
a pair of orthogonally positioned dipoles within each radiating element, the pair of orthogonally positioned dipoles configured to receive the balanced signal from the balun and to radiate circularly polarized electromagnetic waves;
wherein the antenna module generates a first circularly polarized wave from the first input port and a second circularly polarized wave from the second input port simultaneously and independently.

2. The antenna system of claim 1, wherein the single 4-port hybrid comprises a 3dB power split ratio and a 90-degree phase shift between the first output port and the second output port.

3. The antenna system of claim 1, wherein the first circularly polarized wave comprises a Right-Hand Circularly Polarized wave and the second circularly polarized wave comprises a Left-Hand Circularly Polarized wave.

4. The antenna system of claim 1, wherein the antenna module comprises a flanged tubular spine and three structural wings extending from the flanged tubular spine, the three structural wings configured to function as corner-reflectors for shaping a radiation pattern.

5. The antenna system of claim 1, wherein the antenna module comprises flanged legs configured to permit stacking of additional antenna modules.

6. The antenna system of claim 5, wherein each additional antenna module is rotated approximately 120 degrees relative to an adjacent antenna module to enhance pattern circularity.

7. The antenna system of claim 1, wherein each radiating element comprises a pressurized case and an insulator disposed within the pressurized case.

8. The antenna system of claim 7, wherein the pressurized case comprises a diameter of approximately 6-1/8 inches.

9. The antenna system of claim 1, wherein the pair of orthogonally positioned dipoles comprises a right-slant dipole and a left-slant dipole, each dipole comprising a bent dipole configuration.

10. The antenna system of claim 9, wherein each dipole comprises two arm segments, each arm segment comprising a diameter between 3 inches and 6 inches.

11. The antenna system of claim 1, wherein the power divider comprises a 6-way center-fed power divider.

12. The antenna system of claim 1, wherein each balun comprises a gap-fed choke-cavity balun configured to provide a 180-degree phase difference between outputs.

13. The antenna system of claim 1, further comprising toroidal ceramic rings configured to tune and vector impedances of the pair of orthogonally positioned dipoles to achieve a 50 Ohm impedance.

14. The antenna system of claim 1, wherein the antenna module operates across a frequency band of approximately 88 MHz to approximately 108 MHz.

15. The antenna system of claim 1, further comprising combiner modules configured to combine signals from a plurality of FM stations into the first multiplexed signal group and the second multiplexed signal group.

16. A radiating element for circularly polarized broadcasting, comprising:
a first dipole and a second dipole positioned orthogonally to each other, wherein the first dipole comprises a first physical length and the second dipole comprises a second physical length different from the first physical length;
a gap-fed balun coupled to the first dipole and the second dipole, the gap-fed balun configured to receive a single input signal and to provide a balanced feed to the first dipole and the second dipole;
wherein a difference between the first physical length and the second physical length creates an inherent phase shift of approximately 90 degrees between the first dipole and the second dipole; and
wherein the first dipole and the second dipole are configured to radiate a circularly polarized electromagnetic wave based on the inherent phase shift and the orthogonal positioning.

17. The radiating element of claim 16, wherein the gap-fed balun comprises a choke cavity, quarter-wave coaxial lines, and a coupling gap.

18. The radiating element of claim 16, wherein the radiating element comprises a single coaxial input port.

19. The radiating element of claim 16, wherein the circularly polarized electromagnetic wave comprises one of a Right-Hand Circularly Polarized wave or a Left-Hand Circularly Polarized wave based on a relationship between the first physical length and the second physical length.

20. The radiating element of claim 16, wherein the first dipole and the second dipole each comprise a bent dipole configuration with two arm segments.
